(19) United States
(12) Patent Application Publication
(10) Pub. No.: US 2017/0329830 A1
(43) Pub. Date: Nov. 16, 2017

(54) READ-OPTIMIZED DATABASE CHANGES

(71) Applicant: Hewlett Packard Enterprise Development LP, Houston, TX (US)

(72) Inventors: Alkis Simitsis, Santa Clara, CA (US); William K. Wilkinson, San Mateo, CA (US); Vaibhav Arora, Palo Alto, CA (US)

(21) Appl. No.: 15/529,782

(22) PCT Filed: Nov. 26, 2014
(86) PCT No.: PCT/US2014/067633

§ 371 Date: May 25, 2017

(51) Int. Cl. G06F 17/30

(52) U.S. Cl. CPC G06F 17/30563; G06F 17/30575; G06F 17/30377; G06F 17/30442

(57) ABSTRACT

Example implementations relate to read-optimized database changes. For example, a computing device may include at least one processor. The at least one processor may receive a change associated with a read-optimized database and may identify at least one hot attribute associated with the change. The at least one processor may generate an insert operation based on the change using the at least one hot attribute and may send the insert operation to a hot table associated with the read-optimized database.

### BACKGROUND

Many entities (e.g., enterprises, organizations, computer applications, etc.) utilize databases for storage of data relating to the entities. The data in a database may be received from a data stream of incoming data. Data stored in these databases may be accessed and analyzed for various purposes.

### BRIEF DESCRIPTION OF THE DRAWINGS

Some examples of the present application are described with respect to the following figures:

FIG. 1 is a block diagram of an example hybrid database management system for processing changes to a read-optimized database:

FIG. 2 is a block diagram of a computing device for processing changes to a read-optimized database; and

FIG. 3 is a flowchart illustrating an example method of processing changes to a read-optimized database.

### DETAILED DESCRIPTION

As described above, data stored in a database may be accessed and analyzed for various purposes. A database management system (DBMS) may manage and control access to a particular database in response to queries for data. Typically, a DBMS may be optimized for a particular type of workload, such as transaction processing relating to a write-optimized database or analytical processing relating to a read-optimized database. A write-optimized database may be a database optimized such that data may be more easily and quickly written to the database. A read-optimized database may be a database optimized such that data may be more easily and quickly read from the database. An example of transaction processing includes online transaction processing (OLTP), and an example of analytical processing includes online analytical processing (OLAP). OLTP pertains to a class of information systems that may facilitate and manage transaction-oriented applications, such as data entry and retrieval transaction processing. OLAP is an approach to answering multi-dimensional analytical queries, such as business reporting. OLTP requests may be relatively short and may read or write only a few database records, while OLAP requests may be relatively long, may access a large number of records, and may allow primarily read-only access. Because read-optimized databases are optimized for read operations, the data in these databases is organized such that update operations updating data in the database and/or delete operations deleting data in the database may perform poorly. However, insert operations inserting data in the database may perform better than update and/or delete operations because data is simply inserted into the database.

A hybrid DBMS having a synchronization engine may be utilized to optimize access to and/or modification of both a write-optimized database and a read-optimized database, providing a unified framework capable of providing high performance for both write-optimized and read-optimized workloads concurrently. When a read-optimized database is to be modified by changes (e.g., update operations, delete operations, insert operations, etc.) received by the synchronization engine, the synchronization engine may convert any update operations and/or delete operations into insert operations such that the changes may be more efficiently implemented on the read-optimized database. In some examples, the features of the hybrid DBMS may be implemented as a module on top of existing write-optimized and read-optimized DBMSs. The write-optimized and read-optimized databases contain at least some common data, but the common data in each database may be stored in different representations, where the common data in the write-optimized database may be the current version of the common data while the corresponding common data in the read-optimized database may be the current version or a previous version of the common data. The synchronization engine of the hybrid DBMS may manage the synchronization of modifications from the write-optimized database to the read-optimized database to ensure that modifications to the write-optimized database are propagated to the read-optimized database efficiently. An interface module of the hybrid DBMS may be used to interface the hybrid DBMS with one or more applications such that the hybrid DBMS may appear to the applications as a single DBMS. In some examples, the hybrid DBMS is not a federated system, and the interface module may control access and/or updates to the write-optimized and read-optimized database engines. As such, any applications accessing and/or updating the write-optimized and read-optimized databases through the interface module do not directly access the write-optimized and read-optimized databases.

As described above, the features of the hybrid DBMS may be implemented as a module external to existing write-optimized and read-optimized DBMSs. To efficiently send changes to a logical table in a read-optimized database, the hybrid DBMS may store the table as at least two tables, a hot table and a cold table each associated with the logical table in the database. The hot table may be a table of hot attributes associated with the logical database table, where a hot attribute may be any attribute (e.g., table column) that contains values that are likely to be modified relatively more frequently than values for other attributes in the database table. The cold table may be a table of cold attributes associated with the logical database table, where a cold attribute may be any attribute that contains values that are likely to be modified relatively more rarely than values for other attributes in the database table. For example, a database table may include data relating to stock inventory of a business's items, such as an item identifier, the quantity of the item in stock, a description of the item, a warehouse identifier, the year-to-date sales of the item, and the like. For this example logical database table, a hot table may be created and may contain relatively more frequently modified attributes, such as the quantity of the item in stock and the year-to-date sales. A cold table may be created and may contain relatively less frequently modified attributes, such as an item identifier, a description of the item, and a warehouse identifier. In some examples, the hot and cold tables may also contain attributes defining a unique identifier for rows in the logical table (e.g., an item identifier).

In some examples, the hybrid DBMS may also create and maintain a warm table associated with a database table in the read-optimized database. The warm table may be a table that is periodically generated to include the most recent values for attributes in the hot table. In the example above for stock inventory of a business's items, assuming the quantity and year-to-date sales attributes in the hot table are modified approximately once per minute, a warm table may periodically (e.g., each hour, each day, each week, etc.) be generated, where the warm table may contain the most recent quantity value for each inventory item and the year-to-date sales. For a given item, this value may come from the hot table if the quantity and/or sales were recently changed, or from the existing warm table if the values were not changed. The warm table may be generated at any time based on policies specified by a management engine of the hybrid DBMS (e.g., after a specified amount of time has elapsed since the previous warm table update). In some examples, when the warm table is generated, the data in the hot table may be deleted because the most recent data may reside in the warm table. In other examples, the data in the hot table may be kept for any amount of time.

When the synchronization engine of the hybrid DBMS receives a change to be applied to the read-optimized database, the synchronization engine may determine whether the change includes an update operation and/or a delete operation. If the change includes an insert operation, the insert operation is converted to two insert operations to the database engine for the read-optimized database, one each to the hot and cold tables that store the logical table. If the change includes an update operation and/or a delete operation, the synchronization engine may identify one or more hot attributes associated with the change and may convert the change to an insert operation using the one or more hot attributes identified. For example, if the change includes updating a quantity for a particular item, instead of updating the quantity value in the database table, the synchronization engine may generate an insert operation that inserts the new quantity value in the hot table associated with the database table. In order to determine the most recent change to an item quantity, a hot table may also include a timestamp attribute indicating the time when the change occurred. To indicate the deletion of an item, a hot table may also include a Boolean delete flag that may be set to false for attribute updates and set to true for row entries that are to be deleted. In some examples, the timestamp and delete flag may be combined into a single attribute as a state flag indicating a state associated with the change. The state flag may be any suitable flag indicator indicating the particular state of the change such that it may be determined whether the change is the most recent change or whether the row entry is to be deleted. For example, the change may be converted to insert a new quantity of 500 with sales of $5000 (e.g., the values associated with hot attributes) for item X at timestamp Y (e.g., the state flag) into a new row in the hot table. As such, the hot table may have rows of data, where a row may include one or more inserted values and a state flag indicating the state of the corresponding inserted values, and the hot table may be used to determine the most recent data. If an update and/or delete operation applies to a cold attribute, then the operation may not be modified to an insert operation, and the update and/or delete operation may be sent to the cold table associated with the logical table in the read-optimized database. This may be a rare occurrence since, if values associated with an attribute changes relatively often, the values associated with those attributes may be stored in the hot table. If an update operation applies to both cold and hot attributes of a logical table, the operation may be split into two operations to create an insert operation inserting new values associated with hot attributes in the corresponding hot table and an update operation updating values associated with cold attributes in the corresponding cold table.

In some examples, the changes may be applied to a read-optimized database having a table that may be modified with hot attributes (e.g., a stock inventory table). In some examples, the changes may be applied to a read-optimized database having a table that may be modified with state changes such that a row of the table may evolve and/or change until all the attributes of the row are stable and may not, or are unlikely to, change in the future. An example of a table that may be modified with state changes is a table of order fulfillment data, where a row of data may correspond to a purchase order and some attributes in the row may be updated as events occur (e.g., order received, payment received, order packaged for shipping, order shipped, order delivered, etc.). For example, at some point during an order fulfillment process (e.g., upon delivery of an order), all attributes of a row corresponding to an order may have their final values, and the order may be considered stable. In some examples, for logical tables that may be modified with state changes as described above, each logical table may be associated with at least three tables: a table containing only stable rows (e.g., orders that are unchanging or unlikely to change), a table containing stable attributes for active rows (e.g., orders that may still be changing), and a table containing changing attributes for active rows. For example, consider a logical table for orders that may contain an order identifier, an order amount, an order date, a payment date, and a delivery date. The table containing only stable rows (e.g., order_stable) may include all attributes for finalized (e.g., delivered) orders. The table containing stable attributes for active rows (e.g., order_active) may contain the stable attributes for orders still being processed (e.g., order identifier attribute, order amount attribute, order date attribute, etc.). The table containing changing attributes for active rows (e.g., order_hot) may contain the changeable attributes for orders still being processed (e.g., order identifier attribute, payment date attribute, delivery date attribute, etc.). These tables may include a state flag indicating the state of the change (e.g., a timestamp attribute, a delete flag attribute, etc.) such that the most recent data for a row may be retrieved. In some examples, a warm table may be used to store the most recent values associated with hot attributes for an order.

A principle of logical database independence separates the physical storage design of a database from its logical design. Application programs may be written using the logical design, and this may allow the physical design to be changed without affecting existing applications. In examples where a logical table is stored as at least two physical tables (e.g., a hot table and a cold table), logical database independence may be supported in the read-optimized database by using a database view that joins the hot and cold tables on primary key. In examples where a logical table is stored as at least three physical tables (e.g., for state changes), logical database independence may be supported in the read-optimized database by using a database view that joins the stable, active, and hot tables on primary key. This may provide the illusion of a single logical table to applications. In some examples, a cold table may not have a delete flag attribute because the hot and cold tables may be joined on primary key, and if a row was deleted, the delete flag of the hot table may eliminate the row for the item in the hot table such that the deleted row in the hot table may not join to the cold table. In examples utilizing a warm table, the logical database table may be viewed by combining the warm table and the cold table associated with the database table. However, if applications request the freshest data, an additional view may be defined over the cold, warm, and hot tables. For other data modification scenarios (e.g., an order fulfillment table), similar views may be defined.

To establish database consistency for a given transaction over a write-optimized database, all data changes made by that transaction are to be applied in a transactional manner to the read-optimized database. Further, a sequence of transactions committed to the write-optimized database may be applied in the same order to the read-optimized database. To ensure this, in some examples, data modifications may be extracted from the read-optimized database after each commit, the changes may be transformed to insert operations, and the changes may be applied as a single transaction to the read-optimized database. In other examples, the hybrid DBMS may periodically extract a set of modifications for a sequence of recent transactions and may apply all changes as a batch in a single transaction to the read-optimized database. Another example of batch transactions involves updating warm tables using corresponding hot tables. To preserve a consistent view of the database by other concurrent transactions, this refresh of the warm tables may be done as a transactional operation. As such, the synchronization engine of the hybrid DBMS may perform the independent processes of extracting, loading, and refreshing of data. The extracting process collects transaction modifications from the write-optimized database and creates a corresponding batch of changes for the read-optimized database. The loading process may add this fresh data to the hot and/or state tables of the read-optimized database and may modify corresponding cold tables if such changes are applicable to the batch. The refreshing process may update warm, stable, and/or active tables based on the corresponding hot and/or state tables and may optionally drop old versions of data no longer needed. The management engine of the hybrid DBMS may initiate these processes at any suitable time according to policies determined by applications and/or the state of the hybrid DBMS.

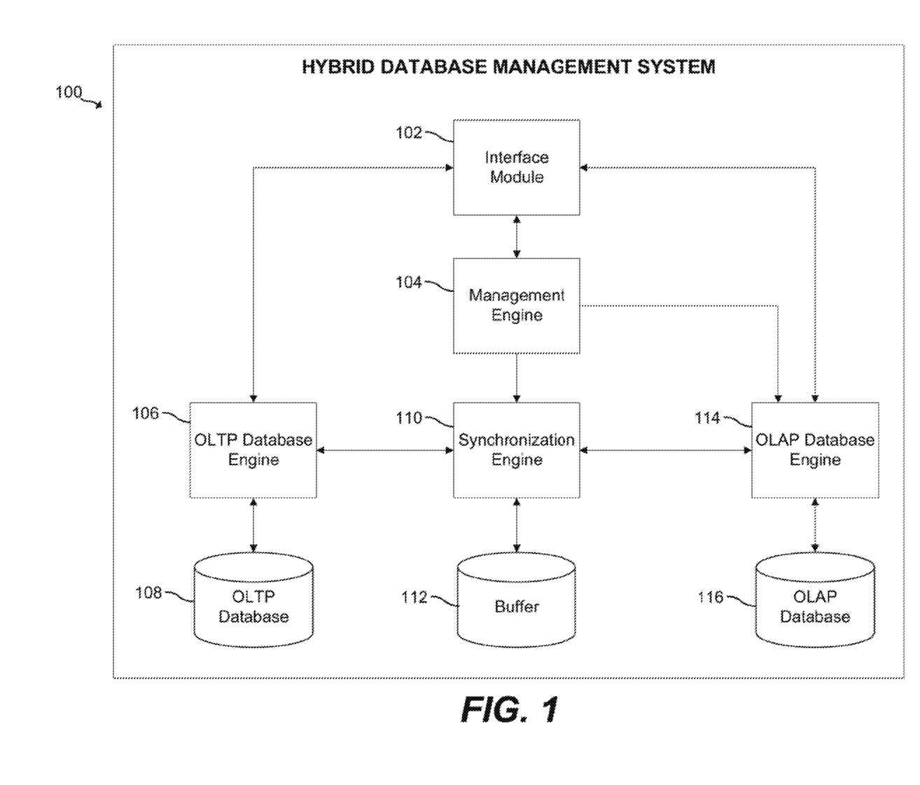

Referring now to the figures, FIG. 1 is a block diagram of an example hybrid DBMS 100 for processing changes to a read-optimized database. The components of hybrid DBMS 100 may operate using one or more processors (not shown) to perform the functions of the components.

Interface module 102 is a hardware-implemented and/or processor-implemented module that provides one or more unified application programming interfaces (APIs) to any applications to allow communication between the applications and hybrid DBMS 100. Interface module 102 may maintain session and transaction context, accept requests for data, forward those requests to the appropriate DBMS (e.g., OLTP database engine 106 or OLAP database engine 114) for processing, and return results in response to the requests.

OLTP database engine 106 is a hardware-implemented and/or processor-implemented module that manages and controls writing data to OLTP database 108, reading data from OLTP database 108, and processing OLTP requests. OLTP database 108 may be any suitable database optimized for OLTP. While examples disclosed herein describe an OLTP database engine and an OLTP database, one of ordinary skill in the art will recognize that any suitable write-optimized database engine and write-optimized database may be used with the techniques described herein.

OLAP database engine 114 is a hardware-implemented and/or processor-implemented module that manages and controls writing data to OLAP database 116, reading data from OLAP database 116, and processing OLAP requests. OLAP database 116 may be any suitable database optimized for OLAP. While examples disclosed herein describe an OLAP database engine and an OLAP database, one of ordinary skill in the art will recognize that any suitable read-optimized database engine and read-optimized database may be used with the techniques described herein.

Synchronization engine 110 is a hardware-implemented and/or processor-implemented module that may manage and control the synchronization of data between OLTP database engine 106 and OLAP database engine 114. For example, synchronization engine 110 may collect changes to table rows in OLTP database 108 from OLTP database engine 106, cache the changes locally in buffer 112, and load the changes to the OLAP database engine 114 for storage in OLAP database 116 at the appropriate time and/or in the appropriate manner based on specified criteria. Buffer 112 may be any suitable storage device capable of storing changes from OLTP database engine 106. Synchronization engine 110 may provide query capability over in-transit data that may be stored in buffer 112 but not yet loaded to OLAP database engine 114. Synchronization engine 110 may also validate transactions. Additionally, synchronization engine 110 may manage and control conversion of changes received from OLTP database engine 106 to insert operations such that the insert operations may be sent to hot tables associated with OLAP database 116 via OLAP database engine 114. For example, synchronization engine 110 may receive a change that includes an update operation and/or a delete operation, identify at least one hot attribute associated with the change, generate an insert operation based on the change using the at least one hot attribute, and send the insert operation to OLAP database engine 114 such that the insert operation may be inserted into hot tables associated with the OLAP database 118. Synchronization engine 110 may ensure transactional consistency such that applications using OLAP database engine 114 may see a consistent view of OLAP database 116. For example, if an OLTP transaction modifies two tables in OLTP database 108, synchronization engine 110 may ensure that hot tables in OLAP database 116 affected by that transaction are updated automatically and at the same time such that OLAP applications may see either all of those updates or none of those updates.

Management engine 104 is a hardware-implemented and/or processor-implemented module that provides various management functions, such as managing criteria specifying a manner of sending changes from buffer 112 to OLAP database engine 114 for storage in OLAP database 116, determining when and/or how to collect changes from OLTP database 108 and store them in buffer 112, determining when and/or how to initiate transfer of changes from buffer 112 to OLAP database engine 114 for storage in OLAP database 116, managing garbage collection of old data, and the like.

For explanatory purposes, an example of applying changes to a read-optimized database is provided below. The example shows attributes of a stock inventory table that maintains data associated with a business's items in stock at various warehouses. The example stock inventory table may have the following attributes:

S_W_ID INT, which corresponds to the warehouse identifier
S_I_ID INT, which corresponds to the item identifier
S_QUANTITY DECIMAL(4,0), which corresponds to the quantity available
S_YTD DECIMAL(8,2), which corresponds to the quantity sold year-to-date
S_ORDER_CNT INT, which corresponds to the number of orders for this item
S_REMOTE_CNT INT, which corresponds to the number of orders for this item from a
different warehouse
S_DATA VARCHAR(50), which corresponds to the item description
S_DIST_01 CHAR(24), which corresponds to the item-specific data for warehouse district 1
S_DIST_02 CHAR(24), which corresponds to the item-specific data for warehouse district 2
S_DIST_03 CHAR(24), which corresponds to the item-specific data for warehouse district 3
S_DIST_04 CHAR(24), which corresponds to the item-specific data for warehouse district 4
S_DIST_05 CHAR(24), which corresponds to the item-specific data for warehouse district 5
S_DIST_06 CHAR(24), which corresponds to the item-specific data for warehouse district 6
S_DIST_07 CHAR(24), which corresponds to the item-specific data for warehouse district 7
S_DIST_08 CHAR(24), which corresponds to the item-specific data for warehouse district 8
S_DIST_09 CHAR(24), which corresponds to the item-specific data for warehouse district 9
S_DIST_10 CHAR(24), which corresponds to the item-specific data for warehouse district 10
PRIMARY KEY (S_W_ID,S_I_ID)

When items are sold by the business in a particular transaction, the items are identified in a purchase order. For each item associated with a purchase order, the item record for the supplying warehouse may be updated in the stock inventory table. Specifically, the quantity, year-to-date count, order count, and remote counts may be updated. The values for these attributes may constitute hot values of the stock inventory table. As such, the stock inventory table may be associated with the following schema for a stock inventory hot table, a stock inventory cold table, and a view that provides application programs with an appearance of a single stock inventory table:

```
CREATE TABLE STOCK_HOT (
  S_W_ID INT
  S_I_ID INT
  S_QUANTITY DECIMAL(4,0)
  S_YTD DECIMAL(8,2)
  S_ORDER_CNT INT
  S_REMOTE_CNT INT
  S_TS TIMESTAMP
  S_DF BOOLEAN
  PRIMARY KEY (S_W_ID,S_I_ID));
CREATE TABLE STOCK_COLD (
  S_W_ID INT
  S_I_ID INT
  S_DATA VARCHAR(50)
  S_DIST_01 CHAR(24)
  S_DIST_02 CHAR(24)
  S_DIST_03 CHAR(24)
  S_DIST_04 CHAR(24)
  S_DIST_05 CHAR(24)
  S_DIST_06 CHAR(24)
  S_DIST_07 CHAR(24)
  S_DIST_08 CHAR(24)
  S_DIST_09 CHAR(24)
  S_DIST_10 CHAR(24)
  PRIMARY KEY (S_W_ID,S_I_ID));
CREATE VIEW STOCK AS
  SELECT C.S_W_ID, C.S_I_ID,
    H.S_QUANTITY, H.S_YTD, H.S_ORDER_CNT,
    H.S_REMOTE_CNT, C.S_DATA,
    C.S_DIST_01, C.S_DIST_02, C.S_DIST_03.
    C.S_DIST_04, C.S_DIST_05,
    C.S_DIST_06, C.S_DIST_07, C.S_DIST_08,
    C.S_DIST_09, C.S_DIST_10
  FROM STOCK_CLD C,
    (SELECT S_W_ID, S_I_ID, S_QUANTITY, S_YTD,
      S_ORDER_CNT, S_REMOTE_CNT, max(S_TS) as S_TS,
      S_DF
    FROM STOCK_HOT
  GROUP BY S_W_ID, S_I_ID, S_QUANTITY, S_YTD,
    S_ORDER_CNT, S_REMOTE_CNT) H
WHERE H.S_I_ID = C.S_I_ID AND
H.S_W_ID = C.S_W_ID AND H.S_DF = FALSE;
```

As shown above, the stock inventory hot table may include attributes such as the warehouse identifier, the item identifier, the quantity available, the quantity sold year-to-date, the number of orders for this item, the number of orders for this item from a different warehouse, a timestamp, and a delete flag. The stock inventory cold table may include the warehouse identifier, the item identifier, the item description, and the item-specific data for warehouse districts 1-10. The view may be used by analytic queries to retrieve all attributes of the current stock data. It may retrieve the latest version of the hot attributes for each stock item in a warehouse by retrieving the attributes with the latest timestamp (e.g., max(S_TS)). It may then merge these attributes with the corresponding cold attributes by joining on the primary key.

When a stock item is updated in the OLTP database, the updated values may be inserted as a new row in the OLAP database in the STOCK_HOT table with the timestamp of the update and the delete flag set to false. When a stock item is deleted, a new row is inserted into the STOCK_HOT table with the timestamp of the deletion and with the delete flag set to true. The delete flag may indicate that the row is to be deleted and should not be returned by the STOCK view.

Over time, the STOCK_HOT table may grow as it accumulates old versions of attributes. The old versions may be deleted through garbage collection. There are various ways to accomplish garbage collection. The garbage collection process may preserve transactional consistency such that the applications programs running concurrently with this process are provided with a consistent view of OLAP database 116. An example of a garbage collection process for the stock inventory table example may be performed by suspending inserts to the hot table and copying the latest versions of stock items from the hot table into a new table STOCK_HOT_NEW, ignoring the rows where the delete flag is true in the process. This may be done concurrently with other query requests. An atomic schema operation may be used to delete the STOCK_HOT table and rename STOCK_HOT_NEW to STOCK_HOT. Insert operations may then resume on the STOCK_HOT table. If there are multiple hot tables to be garbage collected at the same time, the rename operations may be deferred until new tables have been created to ensure consistent views of the database for applications. In the case of warm tables, a similar approach may be employed to refresh the warm tables while garbage collecting the hot tables.

Given the framework disclosed herein, numerous optimizations may be possible depending on the needs of the application. For example, since the hot table records old versions of attribute values, applications may choose to query the stock level for some previous point in time. As previously described, a warm table may be used in addition to the hot table, where the warm table contains a snapshot of the most recent values of attributes in the hot table at a specific point in time. This may avoid a group-by operation. Alternatively, some applications may prefer faster query performance rather than have the freshest data. In this case, it may be possible to keep a second copy of the stock inventory table that has both hot and cold attributes but with older data. Applications may read stock level data directly from this table without the overhead of a group by and join operation. This table may be periodically updated using a technique similar to that for garbage collection. Another optimization includes dropping the delete flag attribute for tables where no delete operation may occur (e.g., in an append-only table). As previously described, different physical schema may also be employed for different update scenarios (e.g., table rows that proceed through a series of state changes and then become stable and unlikely to change in the future).

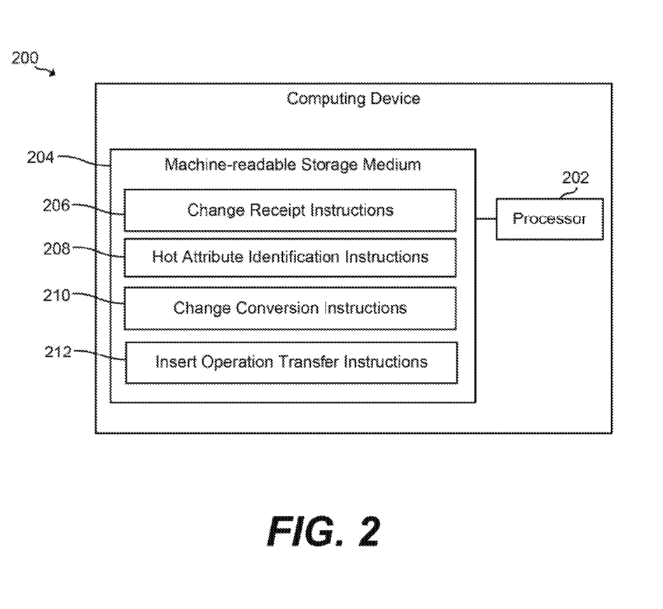

FIG. 2 is a block diagram of an example computing device 200 for processing changes to a read-optimized database. In some examples, computing device 200 may be a synchronization engine, such as synchronization engine 110 of FIG. 1.

Computing device 200 may be, for example, a web-based server, a local area network server, a cloud-based server, a notebook computer, a desktop computer, an al-in-one system, a tablet computing device, a mobile phone, an electronic book reader, a printing device, or any other electronic device suitable for processing changes to a read-optimized database, such as OLAP database 116 of FIG. 1. Computing device 200 may include a processor 202 and a machine-readable storage medium 204. Computing device 200 may convert changes associated with a read-optimized database to insert operations and send those insert operations to a hot table associated with the read-optimized database.

Processor 202 is a tangible hardware component that may be a central processing unit (CPU), a semiconductor-based microprocessor, and/or other hardware devices suitable for retrieval and execution of instructions stored in machine-readable storage medium 204. Processor 202 may fetch, decode, and execute instructions 206, 208, 210, and 212 to control a process of processing changes to a read-optimized database. As an alternative or in addition to retrieving and executing instructions, processor 202 may include at least one electronic circuit that includes electronic components for performing the functionality of instructions 206, 208, 210, 212, or a combination thereof.

Machine-readable storage medium 204 may be any electronic, magnetic, optical, or other physical storage device that contains or stores executable instructions. Thus, machine-readable storage medium 204 may be, for example, Random Access Memory (RAM), an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with a series of processor executable instructions 206, 208, 210, and 212 for receiving a change associated with a read-optimized database (e.g., an OLAP database), identifying at least one hot attribute associated with the change, converting the change to an insert operation using the at least one hot attribute, and sending the insert operation to a hot table associated with the read-optimized database.

Change receipt instructions 206 may manage and control receipt of one or more changes to be applied to read-optimized database. For examples, the changes may include updates, insertions, and/or deletions associated with the read-optimized database.

Hot attribute identification instructions 208 may manage and control identification of at least one hot attribute associated with the change. For example, hot attribute identification instructions 208 may manage and control identification of any attributes associated with the received change that may be modified more frequently relative to other attributes within the read-optimized database.

Change conversion instructions 210 may manage and control the conversion of the change to an insert operation using the at least one hot attribute identified by hot attribute identification module instructions 208. For example, if the change includes an update operation and/or a delete operation, change conversion instructions 210 may convert the change to an insert operation using the at least one hot attribute associated with the change. If the change includes an insert operation conversion may not be performed.

Insert operation transfer instructions 212 may manage and control the transfer of the insert operation to a hot table associated with the read-optimized database. For example, insert operation transfer instructions 212 may send the insert operation to a hot table associated with the read-optimized database such that the data associated with the insert operation may be inserted in the hot table.

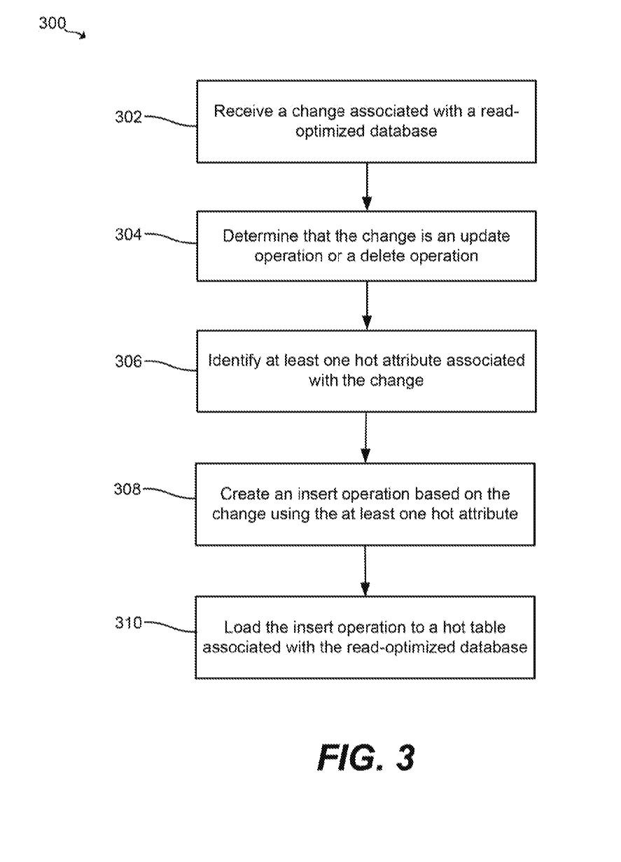

FIG. 3 is a flowchart illustrating an example method 300 of processing changes to a read-optimized database. Method 300 may be implemented using computing device 200 of FIG. 2.

Method 300 includes, at 302, receiving a change associated with a read-optimized database. The change may include any changes to be applied to the read-optimized database, such as updates, insertions, deletions, and the like.

Method 300 also includes, at 304, determining that the change is an update operation or a delete operation. For example, it may be determined whether the change is an update operation or a delete operation, and if so, method 300 may continue to 306. If the change is not an update or a delete operation (e.g., the change is an insert operation), the change may be forwarded to the read-optimized database.

Method 300 also includes, at 306, identifying at least one hot attribute associated with the change. For example, any attributes associated with the change that may be modified more frequently relative to other attribute within the read-optimized database may be identified.

Method 300 also includes, at 308, creating an insert operation based on the change using the at least one hot attribute. For example, the change may be converted to an insert operation that inserts the at least one hot attribute into the read-optimized database.

Method 300 also includes, at 310, loading the insert operation to a hot table associated with the read-optimized database. For example, the insert operation may be loaded to the hot table such that the at least one hot attribute associated with the change may be inserted into the hot table of the read-optimized database.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (‘SSD’), flash memory, phase change memory, and the like.

What is claimed is:

1. A system comprising:
at least one processor to:
receive a change associated with a read-optimized database;
identify at least one hot attribute associated with the change;
generate an insert operation based on the change using the at least one hot attribute; and
send the insert operation to a hot table associated with the read-optimized database.

2. The computing device of claim 1, wherein the at least one processor is further to identify the change as an update operation or a delete operation.

3. The computing device of claim 1, wherein the insert operation includes a state flag indicating a state associated with the change, the state flag being a timestamp or a count.

4. The computing device of claim 1, wherein the change is a delete operation and wherein the insert operation includes a delete flag indicating a deletion of the at least one hot attribute.

5. The computing device of claim 1, wherein the at least one processor is further to:
receive a query associated with the read-optimized database; and
process the query using the hot table and a cold table associated with the read-optimized database, the query being processed based on a state flag indicating a state associated with the change.

6. The computing device of claim 1, wherein the read-optimized database includes a warm table generated periodically based on the most recent values in the hot table.

7. A method comprising:
receiving, by a computing device, a change associated with a read-optimized database;
determining, by the computing device, that the change is an update operation or a delete operation;
identifying, by the computing device, at least one hot attribute associated with the change;
creating, by the computing device, an insert operation based on the change using the at least one hot attribute; and
loading, by the computing device, the insert operation to a hot table associated with the read-optimized database.

8. The method of claim 7, wherein the insert operation includes a state flag indicating a state associated with the change, the state flag being a timestamp or a count.

9. The method of claim 7, wherein the change is the delete operation and wherein the insert operation includes a delete flag indicating a deletion of the at least one hot attribute.

10. The method of claim 7, further comprising:
receiving a query associated with the read-optimized database; and
processing the query using the hot table and a cold table associated with the read-optimized database, the query being processed based on a state flag indicating a state associated with the change.

11. A non-transitory machine-readable storage medium storing instructions that, if executed by at least one processor of a computing device, cause the computing device to:
receive a change associated with an online analytical processing (OLAP) database;
identify at least one hot attribute associated with the change;
convert the change to an insert operation using the at least one hot attribute; and
send the insert operation to a hot table associated with the OLAP database.

12. The non-transitory machine-readable storage medium of claim 11, wherein the at least one processor is further to identify the change as an update operation or a delete operation.

13. The non-transitory machine-readable storage medium of claim 11, wherein the insert operation includes a state flag indicating a state associated with the change, the state flag being a timestamp or a count.

14. The non-transitory machine-readable storage medium of claim 11, wherein the change is a delete operation and wherein the insert operation includes a delete flag indicating a deletion of the at least one hot attribute.

15. The non-transitory machine-readable storage medium of claim 11, wherein the OLAP database includes a warm table generated periodically based on the most recent values in the hot table.
